(19) United States
(12) Patent Application Publication
(10) Pub. No.: US 2012/0038905 A1
(43) Pub. Date: Feb. 16, 2012

(54) DEVICE AND METHOD FOR THE OPTICAL ANALYSIS OF DOCUMENTS

(76) Inventor: Jose Balbuena, Eaubonne (FR)

(21) Appl. No.: 13/254,934

(22) PCT Filed: Mar. 3, 2010
(86) PCT No.: PCT/FR10/50360

§ 371 Date: Oct. 26, 2011

(30) Foreign Application Priority Data
Mar. 3, 2009 (FR) 0951342

(51) Int. Cl. G01N 21/25; G01N 21/64

(52) U.S. Cl. 356/71; 250/459.1

(57) ABSTRACT

The invention relates to an optical analysis method for distinguishing a substance (2) present on a substrate such as an object or a document, wherein said method includes the step (a) of illuminating said substrate with a primary light beam selected in order to interact with the substance (2) so that the latter transmits, within a secondary light beam in the visible spectrum, a characteristic chromatic radiation that is not directly detectable in the secondary light beam, and a detection step (b) that comprises a selective filtration sub-step (b1) during which the secondary light beam is filtered through a spectral window of the visible spectrum adapted to said characteristic chromatic radiation in order to detect the substance (2) from the environment thereof. The invention can be used for the optical analysis of documents.

### BACKGROUND OF THE INVENTION

The present invention relates to the general field of devices and methods for the optical analysis of substances, objects or documents, said methods and devices being operable to detect or characterize substances present on some substrate, and particularly to the field of analysis methods for authenticating a document or detecting a forgery, for example within the framework of judicial enquiries or proceedings.

The present invention relates in particular to a method of optical analysis for discriminating a substance present on a substrate such as an object or a document, said method comprising a step of illumination during which the substrate is exposed to a primary light beam, such that said substrate emits in response a secondary light beam, as well as a step of detection during which said secondary beam is collected and analyzed.

The present invention also relates to an optical analysis device for discriminating a substance present on a substrate such as an object or a document, said device comprising illumination means capable of generating a primary light beam to illuminate the substrate such that said substrate emits in response a secondary light beam, as well as detection means designed for collecting and analyzing said secondary beam.

### PRIOR ART OF THE INVENTION

It is known to use the optical properties of certain substances, and in particular inks, to check the authenticity of documents such as identity documents or values.

In particular, it is known for that purpose to expose the document to the radiation of an ultraviolet lamp so as to excite certain pigments that then radiate, by fluorescence, within the domain of the visible spectrum.

Therefore, the mere exposure to a UV lamp makes it possible to immediately detect the presence or absence of a special ink ensuring the authenticity of the document.

However, such devices suffer from certain limitations.

Firstly, such methods are only adapted for the detection of substances, the chemical nature of which provides them with fluorescent properties under UV.

Furthermore, in some cases, it is advisable to take precautions so as not to excessively expose the user's eyes or skin to said ultraviolet rays, which may be rather aggressive for certain biological tissues.

Besides, infrared analysis devices are known, which permit to explore certain optical properties of the document beyond the visible spectrum.

Although they have undeniable advantages, such devices also suffer from certain limitations.

Firstly, like the devices using ultraviolet rays, the infrared devices can only analyze certain categories of substances sensitive to the specific wavelengths they use.

Secondly, such devices have to convert the image formed in the infrared spectrum, invisible to the naked eye, in order to reproduce an image perceptible by a human user.

Generally, such an image is converted into grey scale, so that the effective discrimination power of such a device may be relatively limited.

Furthermore, such infrared devices, which sometimes implement particularly advanced signal detection and conversion means, may prove to be particularly complex and expensive.

### SUMMARY OF THE INVENTION

Therefore, the objects assigned to the present invention aim to remedy the above-listed drawbacks and to propose a new method of optical analysis for discriminating a substance present on a substrate such as an object or a document, which has a particularly high discrimination power.

Another object of the invention aims to propose a new method of optical analysis, which is particularly versatile.

Another object of the invention aims to propose a new method of optical analysis, which is particularly simple and intuitive to implement.

Another object of the invention aims to propose a new optical analysis device, having an increased discrimination power.

Another object of the invention aims to propose a new optical analysis device, which is very versatility and very flexible to use.

Another object assigned to the invention aims to propose a new optical analysis device, which has a particularly simple, compact and cheap structure.

Another object assigned to the present invention aims to propose a new optical analysis device, which is very ergonomic and particularly intuitive to use.

The objects assigned to the present invention are achieved by means of a method of optical analysis for discriminating a substance present on a substrate such as an object or a document, said method comprising a step of illumination during which the substrate is exposed to a primary light beam, such that said substrate emits in response a secondary light beam, as well as a step of detection during which said secondary beam is collected and analyzed, said method being characterized in that the primary light beam is chosen so as to interact with the substance in such a manner that the latter emits within the secondary light beam, in the domain of the visible spectrum, a characteristic chromatic radiation that is not directly discernable within said secondary light beam, and in that the step of detection comprises a sub-step of selective filtering during which the secondary light beam is filtered, through a spectral window of the visible spectrum adapted to said characteristic chromatic radiation, so as to extract from said secondary beam an image of a surface element of the substrate that is extensive enough to contain at least one area containing the substance and at least one reference area free from said substance, forming the environment of said substance, said image containing simultaneously, on the one hand, a first visible signal corresponding to the characteristic radiation of the substance and, on the other hand, a second visible signal corresponding to the response of the environment, said first and second signals being visually distinct from each other to permit a user to distinguish the substance from the environment thereof.

The object assigned to the invention are also achieved by means of a method of optical analysis for discriminating a substance present on a substrate such as an object or a document, said method comprising a step (a) of illumination during which the substrate is exposed to a primary light beam, such that said substrate emits in response a secondary light beam, as well as a step (b) of detection during which said secondary beam is collected and analyzed, said method being characterized in that the step (a) of illumination comprises a sub-step (a1) of emission adjustment during which the spectral characteristics of emission of the primary beam are determined, among a plurality of possible settings, by means of a metameric source comprising at least one first and one second sources that have distinct spectral characteristics and that are capable of emitting simultaneously, in the visible domain, a first and a second sub-beams, by adjusting the intensity of said first and second sub-beams respectively.

The objects assigned to the invention are finally achieved by means of an optical analysis device for implementing one and/or the other of the above-mentioned methods of optical analysis, and more particularly by means of an optical analysis device for discriminating a substance present on a substrate such as an object or a document, said device comprising illumination means capable of generating a primary light beam to illuminate the substrate such that said substrate emits in response a secondary light beam, as well as detection means designed for collecting and analyzing said secondary beam, said device being characterized in that the illumination means are designed for generating a first light beam adapted to interact with the substance in such a manner that the latter emits within the secondary light beam, in the domain of the visible spectrum, a characteristic chromatic radiation that is not directly discernable within said secondary light beam, and in that the detection means comprise a selective filtering element capable of filtering the secondary light beam through a spectral window of the visible spectrum adapted to said characteristic chromatic radiation, so as to highlight the distinction between the substance and the environment thereof.

### SHORT DESCRIPTION OF THE DRAWINGS

Other objects, features and advantages of the invention will appear in more detail from the following description, with the aid of the appended drawings, given only by way of illustrative and non-limitative example, in which:

FIG. 1 is a schematic view of an optical analysis device according to the invention, for implementing a method of optical analysis according to the invention;

FIGS. 2A, 2B and 2C are schematic views of the implementation of an alternative method of optical analysis according to the invention;

FIGS. 3A and 3B are schematic views of the implementation of an alternative method of optical analysis according to the invention;

FIGS. 4A and 4B show a Table listing various types of selective filtering elements liable to be implemented within an optical analysis device according to the invention, presenting the transmittance of said filters as a function of the wavelength “lambda”. For the sake of description convenience, the squares corresponding to a transmittance considered as being zero, i.e. to a practical absence of bandwidth, have been left blank;

FIGS. 5, 6, 7, 8, 9 and 10 show graphical representations of the spectral curves, corresponding to the transmittance as a function of the wavelength “lambda”, of certain filters mentioned in the Table of FIGS. 4A and 4B;

FIGS. 11A, 11B and 11C show the respective spectral characteristics of emission, illustrating the transmittance as a function of the wavelength “lambda”, of several variants of illumination means used within an optical analysis device according to the invention;

FIG. 12 is a schematic view of a variant of embodiment or use of an optical analysis device according to the invention for implementing a method of optical analysis according to the invention;

FIG. 13 shows the spectral curve of a selective filtering element according to the invention, adapted in particular for the detection of fingerprints or palmprints.

### BEST EMBODIMENT OF THE INVENTION

The present invention relates to an optical analysis device 1 for discriminating a substance 2 present on a substrate 3.

Within the meaning of the invention, the substrate 3 may be of any type, as regard its shape, its size as well as its nature, and the substance 2 may be present on the surface of said substrate or be integrated within the latter.

In particular, the substrate 3 may be formed of any everyday-life object, liable to be moved or not, and made up of any material such as paper, polymer, textile, metal, mineral or organic coating.

According to a particular variant of the invention, the substrate 3 may consist of a cellular culture substrate or a biological, human, animal or vegetal tissue, the device 1 being then operable to detect or observe certain substances, in particular pigments, present in the cells of said tissue or cultivated on the substrate. By way of example, such a device may serve as a tool for observing melanomas in the skin.

However, the device 1 according to the invention is preferably designed for the analysis of documents, and more particularly for identifying certain characteristics of said document and, for example, verifying the authenticity of documents made on a paper substrate or detecting forging of documents.

In this case, the substrate 3 may be, for example, a fiduciary document, an identity document, an official deed, a will, or a monetary document such as a check or a note.

Although the substance 2 can be an intrinsic component of the substrate 3, integrated to this latter, for example, during the fabrication of said substrate, it may also be a foreign substance added on or in said substrate, notably deposited on the surface or impregnated in said substrate.

For example, said substance 2 may result from handwriting, printing, coating, splash projection, or transfer by contact or immersion.

The nature and the chemical composition of the substance 2 may be very varied. The substance 2 can for example consist of an ink, a pigment compound of an ink, an ink additive such as a fixative or a drier agent, a chemical liquid residue, a trace of bodily fluid, such as saliva, sperm or sweat, or an organic compound or even a micro-organism having colonized the substrate, such as fungus or mold.

As such, it can be noticed that, more generally, the device 1 and the methods according to the invention may advantageously constitute investigation tools that permit, in particular, to implement an protocol of exploration aiming to discover, detect, identify, analyze or characterize a substance 2, and more particularly, the aspect, contours or extent thereof on the substrate, and this even when the nature or even the existence of said substance on said substrate 3 are not known nor sure a priori, and when the presence of said substance may result from an unintentional, accidental, non-systematic tag that is not specifically intended to provide a means for identifying or authenticating the object or the document.

In this regard, the device and the methods according to the invention have far higher capabilities and performances than the tools commonly used to authenticate—for example—bank notes, and which are only capable of detecting, by punctually measuring the intensity of certain particular radiations and comparing the results with predetermined values, the presence or absence of a known substance, intentionally integrated as an authentication tag and having well-defined properties, in particular spatial properties (position of the tag with respect to the object) and spectral properties (predetermined behavior of the substance relative to very specific conditions of illumination, in particular the wavelength, or of observation, in particular the angle of detection).

Advantageously, the device 1 according to the invention is adapted for implementing one or several methods according to the invention, as described hereinafter. The descriptive elements relating to the device 1 thus apply mutatis mutandis to the methods, and vice versa.

The device 1 comprises illumination means 4 capable of generating a primary light beam F1 to illuminate the substrate 3, such that said substrate 3 emits in response a secondary light beam F2, as well as detection means 5 designed for collecting and analyzing said secondary beam F2.

Of course, the device may be adapted to any type of secondary beam coming from the substrate and returned by the latter.

Preferably, the detection means 5 are arranged on the same side as the illumination means 4 with respect to the substrate 3, so as to be able to pick up the secondary beam F2.

In particular, the device 1 may be designed for “sounding” thick or substantially opaque substrates.

It may also permit, or even exclusively allow, a reflection analysis of the beam reflected by the substrate.

However, it is also absolutely conceivable, without departing from the scope of the invention, that said device 1 is arranged in such a manner that the detection means 5 can pick up the radiation transmitted and/or diffused through the substrate 3.

In any case, the device 1 according to the invention makes it possible to implement a non-destructive method of analysis, which does not require to spoil or to prepare the substrate 3, notably by a mechanical sample-taking or cutting operation, or by a chemical impregnation, spraying or dipping operation.

According to an important characteristic of the invention, the illumination means 4 are designed for generating a primary light beam F1 adapted for interacting with the substance 2 in such a manner that the latter emits within the secondary light beam F2, in the domain of the visible spectrum, a characteristic chromatic radiation that is not directly discernable within said secondary light beam F2.

Of course, the nature of the interaction between the primary light beam F1 and the substance 2, which is at the origin of the secondary light beam F2, is in no way limited, and may notably consist of a phenomenon of emission of the luminescence type, and in particular fluorescence, through excitation of the substance by means of the primary light beam F1, a phenomenon of reflection, of transmission, a phenomenon of spectral absorption or attenuation of the primary beam F1 by the substance 2, or a phenomenon of decomposition and/or phase-shifting of said primary light beam F1 by said substance 2.

Preferentially, the device 1 is adapted for detecting the secondary light beam F2 resulting from the reflection, notably the partial reflection, of the primary light beam F1, i.e. produced by reflection-absorption of said primary light beam F1 by the substrate 3 and the substance 2 and/or by luminescence of one and/or the other of these elements.

As used herein, “characteristic chromatic radiation” denotes the radiation corresponding to the specific response of the substance 2 when the latter is illuminated by the primary light beam F1, said radiation containing information of chromatic nature liable to permit the visual characterization of said substance and the discrimination thereof with respect to its environment.

As used herein, “chromatic” indicates that the spectrum of the characteristic radiation corresponds to a color, that is to say said radiation has at least one wavelength, and preferably a spectral range, located in the spectrum of perception of the human eye, that provides it with a hue (or “chromatic tone”).

Of course, it does not exclude that a part of the response of the substance 2 to the excitation by the primary light beam F1 is located outside the domain of the visible spectrum, the characteristic chromatic radiation then corresponding to the part of the said response that is contained in the visible spectrum.

As used herein, “visible spectrum” designates the spectral band normally accessible to the human eye, and more particularly, the spectral band substantially comprised between 380 nm and 780 nm, which spectral band advantageously contains the characteristic chromatic radiation.

Preferably, the characteristic radiation is substantially comprised between 400 nm and 700 nm, and in a particularly preferential manner, located at least in part in a domain of the visible spectrum that is lower than or equal to 650 nm, or even lower than or equal to 530 nm, or even lower than or equal to 470 nm.

As used herein, “not directly discernable” means that the distinction between the substance and its environment cannot be visually detected by a direct observation of the secondary light beam F2, that is to say the characteristic radiation of said substance, although it belongs by nature to the spectral domain of perception of the eye, cannot be discriminated by the naked eye from said “raw” secondary light beam in which it is “embedded” when the substrate is illuminated by the illuminating means 4.

That is the reason why, according to another important characteristic of the invention, the detection means 5 comprise at least one selective filtering element 6 that is capable of filtering the secondary light beam F2 through a spectral window of the visible spectrum, said spectral window being adapted to said characteristic chromatic radiation, so as to highlight the distinction between the substance 2 and its environment.

As used herein, “environment” denotes the elements foreign to the substance 2 that are in the same spatial region of the observed substrate 3 as said substance 2, and in particular the substrate 3 itself or other substances of a different chemical nature, which are located on or in said substrate 3, in the vicinity of the substance 2, or even mixed with it or superimposed to it.

Advantageously, the device 1 according to the invention makes it possible to extract from the secondary light beam F2, through a spectral observation window defined by the selective filtering element 6, an image 10 that contains simultaneously, on the one hand, a first visible chromatic signal (or a first set of visible chromatic signals) that corresponds to all or part of the characteristic chromatic radiation, i.e. the specific response of the substance 2 to the illumination by the primary light beam F1, and on the other hand, a second visible chromatic signal (or a second set of visible chromatic signals) that corresponds to a part (filtered) of the whole response of the environment, and that is superimposed to the first visible chromatic signal on the image 10 reproduced by the detection means 5, such that the chromatic difference that exists between said first and second visible chromatic signals becomes immediately visually observable by the user when the latter looks at said image 10.

In other words, the device 1 provides an image 10 of a natural phenomenon of chromatic radiation, and preferentially of luminescence, in which image at least one first signal representative of the substance 2 coexists with another signal representative of the environment of said substance, and more particularly representative of the area(s) of the substrate 3 that are located in the vicinity of said substance and that are not tagged by the latter, said image 10 being visually perceptible and interpretable by the user, so that the latter is then capable to visually discriminate the substance 2 from its environment.

The inventor has indeed noticed that very numerous substances produce a characteristic chromatic radiation in the domain of the visible, notably when said substances are illuminated by a visible light, or even by a UV light, although this phenomenon has been unnoticed up to now because it was “hidden” or “covered” by the whole noise of the secondary light beam F2.

The inventor has also discovered that it is possible to collect the discriminant chromatic information intrinsically present in the secondary light beam F2 and to reveal it to the user by isolating an image 10 of said secondary light beam F2 by means of a simple appropriate spectral filtering, capable of reducing or eliminating a part of the noise caused by the secondary light beam.

Thus, the selective filtering may advantageously be operated by means of relatively “simple” filters defined by the distribution or the specific “proportioning” of the transmittance thereof as a function of the wavelength in the spectral window they define.

Furthermore, it can be noticed that the device 1 and the detection means 5 may have minimalist technical requirements, and in particular operate independently of particular conditions of collimation, focusing, spatial orientation, or polarization of the light beams F1, F2, of the illuminating means 4 or of the selective filtering element.

In particular, the device and the associated methods may be little sensitive to the relative orientation of the illumination means 4 and the detection means 5.

The device is thus rather robust and relatively flexible to use, as it tolerates very varied and little restricting conditions of observation and analysis.

With such qualities, the device is in particular liable to be adapted to the search for many types of substances, unlike the known apparatuses that are generally of the single-task type and reserved to the detection of a single one dedicated substance.

Moreover, those qualities permit to contemplate very variable, and notably very compact, arrangements of the elements of the device 1.

Advantageously, the device 1 is designed for making appear simultaneously to the user, in the domain of the visible spectrum that is directly accessible to the latter, the substance 2 and the environment thereof, in such a manner that they become chromatically distinct from each other, the user being then capable to operate intuitively an immediate visual distinction between the first and the second signals as they appear on the image 10.

For that purpose, the image 10 advantageously makes it possible to view an element of surface of the substrate 3 that is extended enough to contain at least one area containing the substance 2 and at least one area free from said substance and forming a reference area, so as to permit, by comparison, the detection of the analyzed substance 2 with respect to the rendering of the reference area forming the environment in which said substance is inscribed.

Advantageously, it becomes then possible to perceive, on the image of a relatively extended spatial area of the substrate, the geometrical or dimensional characteristics of the tag formed by the substance 2 in or on the substrate 3, and in particular to distinguish the boundary lines of the extent covered by the substance with respect to its environment, and possibly to collect, measure, interpret or analyze, manually or automatically, these characteristics.

Advantageously, the chromatic differences between the substance analyzed and the environment thereof, which can be observed on the image 10 substantially as they naturally preexist, and which was initially “hidden” in the secondary light beam F2, are not limited to simple differences of intensity between the different regions (or areas) of the image 10.

Indeed, according to the invention, the first and second visible chromatic signals can advantageously make appear hue differentials between the substance 2 and its environment, i.e. differences of apparent dominant wavelength, and/or differences of saturation in the observe hue(s), i.e. differences of purity perceptible for a same hue (according to whether the color appears paler or stronger, i.e. more or less “whitened”).

In other words, the image 10 advantageously carries discriminative chromatic information perceptible by the eye, wherein the luminous points forming said image 10 can advantageously be distinguished from each other by differentials of brightness, differences of hue, i.e. of chromatic tone corresponding to their dominant wavelength, as it is perceived by the human eye, but also by differences of saturation, i.e. of purity of the hues observed.

Thus, the device 1 according to the invention has a particularly high discrimination power, notably because it can make a naturally present phenomenon of photochromatic radiation, and notably of luminescence, accessible to the user, i.e. to the human eye. Advantageously, the device 1 reveals this phenomenon, substantially without altering it, and thus by keeping in the image 10 it reproduces a plurality of original elements of information (chromatic differences) based on the different intrinsic parameters of the color, i.e. the optical perception by the human eye of the light waves constituting said phenomenon.

In a particularly advantageous manner, the device 1, and more particularly the detection means 5, are thus capable of preserving at least one, and preferably a plurality of chromatic elements of information, and in a particularly preferential manner, can possibly pick up and reproduce simultaneously several values of each of the three parameters of hue, brightness and saturation of the observed signals, in the different luminous points that constitute the image 10 in the space.

Preferably, the spectral window defined by the selective filtering element 6 covers at least one part of the visible spectral domain located below 650 nm, preferably below 530 nm, or even below 470 nm. Thus, the detection means 5 permit to pick up and reproduce on the image 10 a hue, or even a plurality of hues, present in the secondary light beam and visually observable by the user.

As such, it is possible to substantially avoid the loss of information, and thus the loss of discrimination power, that can be observed for example in the infrared detection systems of the prior art when these latter convert the invisible infrared radiation into a visible image, and thus give access to only one form of discrimination based on grey scale that differ from each other only by their apparent brightness.

Advantageously, the device according to the invention thus permits, with the aid of simple and cheap means, to make apparent a phenomenon that intrinsically preexists in a state potentially perceptible by the human eye, without the measurement of said phenomenon makes disappear the discrimination information contained in said phenomenon.

Furthermore, by allowing the observer to visually make the distinction within a same image 10 between the first signal representative of the substance 2 and the second signal representative of its environment, preferably by hue contrast, the device 1 operates in a “relative” or “floating” mode leaving a great part to the observer's assessment, and requires no absolute reference, and in particular no accurate measurement of intensity or spectral composition of the signals observed, and a fortiori no normalization of such measurements or comparison of these latter to fixed pre-recorded reference values.

This permits to simplify the device 1, and to make the use thereof very intuitive, while providing it with a great versatility that makes it open and immediately adaptable to very varied applications, and in particular to the search for substances 2 whose nature or presence on the substrate is not certain.

Of course, it is however not exclude that the device 1 may comprise a processing unit capable of analyzing the image 10 or measuring accurately all or part of the characteristics, in particular the spectral composition or the intensity, of the secondary beam F2 before or after the selective filtering.

Preferably, the detection means 5 are provided with an acquisition element 7 designed for picking up the filtered secondary light beam F2′ coming from the selective filtering element 6 and for processing said filtered beam to reproduce the image 10 thereof, for example two-dimensionally or three-dimensionally, on a displaying element 8 such as a computer screen.

Of course, the acquisition element 7 may comprise zooming elements for magnifying and/or narrowing the spatial field observed, as well as processing elements, such as amplifiers, for amplifying, for example, the brightness of the received signal.

Advantageously, the constitution, observation and analysis of the image 10 require only one view angle, the acquisition being performed substantially in real time, from a position that is fixed and substantially invariant during the period of observation, without in particular the need to perform several measurements in different points of the space or to perform a complex processing of the data collected.

According to a preferential embodiment variant, which may constitute an invention as such, the acquisition element 7 is made by means of a plain vanilla CCD-sensors video camera, which has been jailbroken, i.e. from which the filters usually used to prevent the CCD cell of said video camera to be blinded by the UV or infrared rays are removed. The video camera then becomes capable of perceiving a wide spectrum including UV, visible and infrared spectra.

Advantageously, such a modification is notably made possible and implemented insofar as the spectrum of emission of the primary light beam F1 can be controlled, so as to emit a little or no infrared, and a little or no UV, as will be described hereinafter.

According to an embodiment variant, the device 1 may be specifically dedicated to the detection of a particular substance, or a family of substances having similar optical properties, and have for that purpose an invariant selective filtering element 6.

However, in a particularly preferential manner, the device 1 comprises configuration means (not shown) for modifying the spectral characteristics of the selective filtering element. In particular, said configuration means may permit to modify the spectral position of the filtering element 6 and/or the spectral width of the bandwidth of said filtering element, i.e. the position of its terminals corresponding to its cut-off wavelength(s), and/or its level of transmittance for either one of the different wavelengths constituting said bandwidth.

According to an embodiment variant, the selective filtering element 6 may then be formed by one or several optical filters than can be arranged alternately, or be superimposed to each other, in the optical path of the secondary light beam F2, by mean of an adapted filter support, such as for example a barrel comprising on its periphery a plurality of slots intended to each accommodate one of said optical filters.

Preferably, the device 1 has an integrated filter support, possibly provided with motorized filter-selection means.

According to another variant of embodiment, the selective filtering element may comprise a “tunable” filter, whose spectral characteristics can be intrinsically modified by a reconfiguration of said filter, for ex by mechanically, electrically or chemically modifying the state of said filter.

More particularly, according to an embodiment variant that may constitute an independent invention, the selective filtering element may comprise a substrate, for example a display screen, whose transparency and/or color can be modified at will by the user.

Advantageously, such a screen may be formed by a liquid crystal color screen, such as those used in association with overhead projectors. The user is therefore able to choose as a function of his/her needs the hue and the opacity of the screen through which passes the secondary light beam F2 and thus to adapt the filtering conditions on a case-by-case basis.

The selective filtering element 6 may be formed by a low-pass filter, a high-pass filter or a band-pass filter.

The bandwidth(s) of said selective filtering element 6, which define the spectral window of observation of the secondary light beam F2, preferably cover at least one part of the visible spectral domain located below 650 nm, preferably below 530 nm, or even below 470 nm.

Preferably, the selective filtering element 6 thus permits to pick up and highlight chromatic radiations that are not limited to the “red” domain, the near-infrared domain and/or the infrared domain, and in particular to include blue or green hue information in the measurement performed, and thus the image 10, which image can besides simultaneously contain or not red chromatic radiations.

Advantageously, according to a characteristic that may constitute an independent invention, the use of such bandwidth(s) permits to collect, through the spectral window, wavelength(s)—and thus chromatic information—located outside the red, and notably in the green and/or the blue, in particular below 650 nm, 530 nm, or even 470 nm, or even, if needed, to cut or attenuate the red or infrared domain located beyond these limits.

Such an arrangement optimizes the discrimination power of the device by showing an image in which the various chromatic tones are not “shaded” by saturation of red and/or infrared, contrary to what happens systematically within the known infrared or near-infrared devices.

The device according to the invention has thus in particular a discrimination power far higher that of the known monochromes devices.

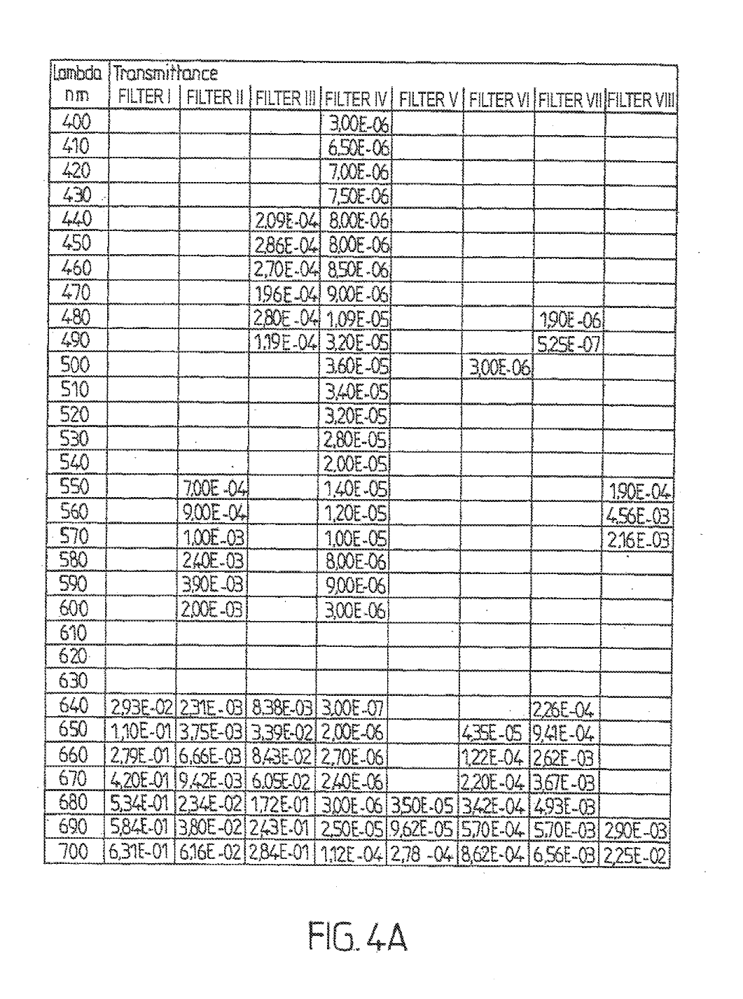

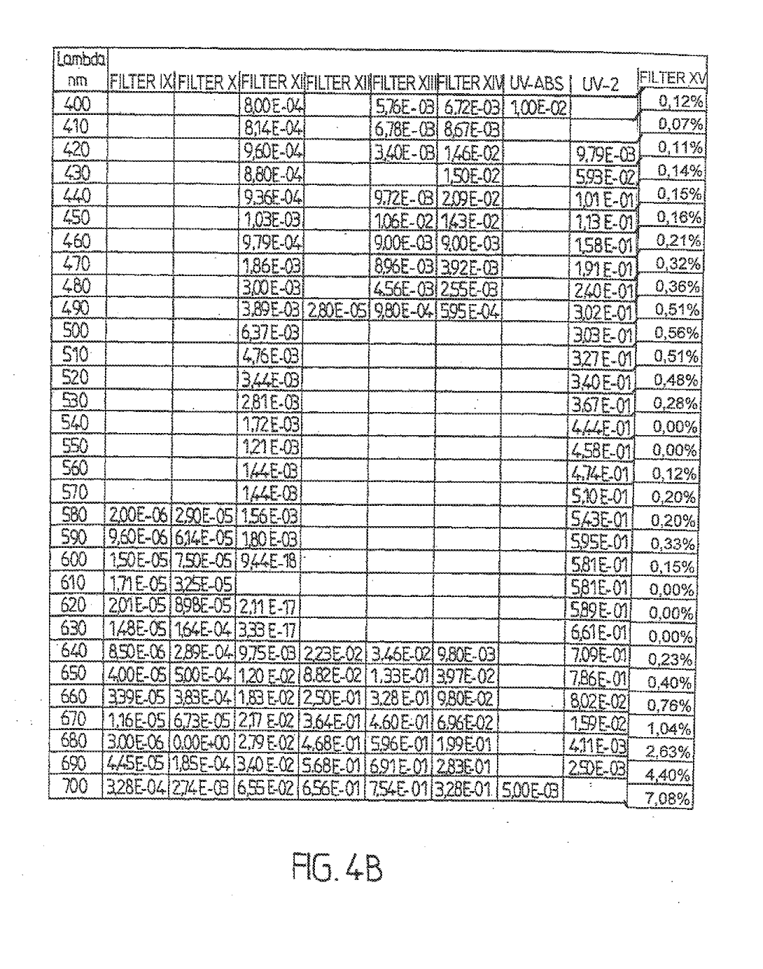

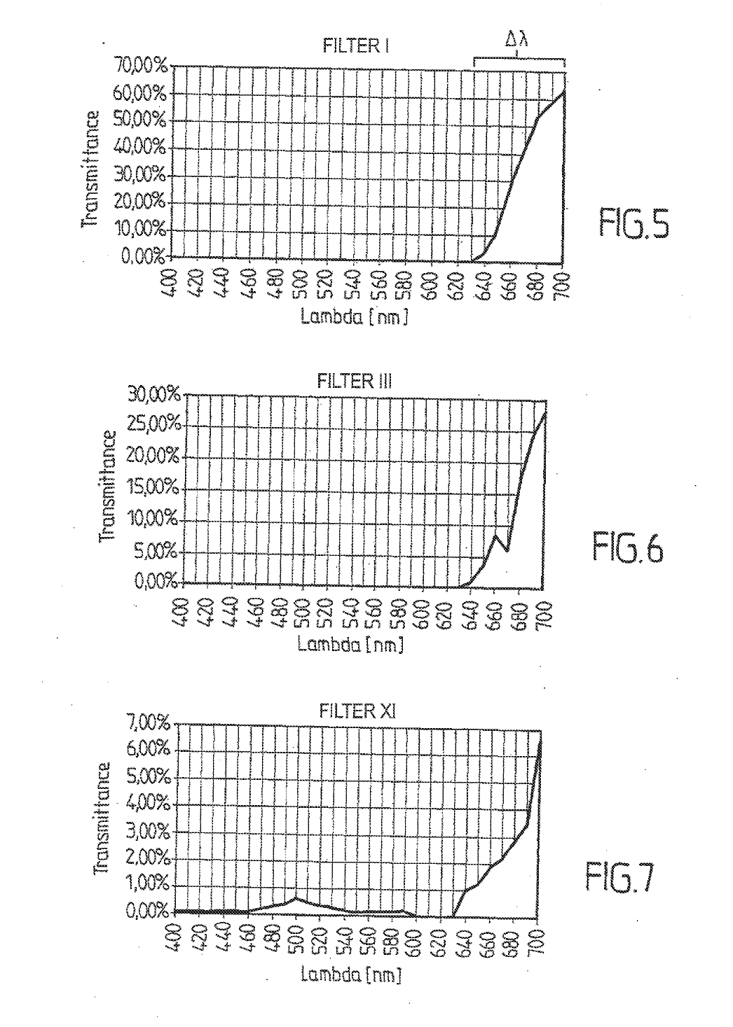

By way of example, one of the filters III, XIII, XIV or UV-2 shown in the Table of FIGS. 4A and 4B may be used as a selective filtering element 6.

Indeed, the inventor has noticed, notably during tests for discriminating inks deposited on the substrate 3 by pens or felts, that filters having at least one first spectral sub-window located in the blue or the green, i.e. substantially between 400 nm and 520 nm, provide remarkable results.

Advantageously, this first spectral sub-window may be associated with a second spectral sub-window, located in the red, i.e. between about 640 nm and 700 nm, or at the very least, may tolerate the presence of the latter in order to simplify the manufacturing of said filters, as it is notably the case for the filters III, XIII and XIV.

Furthermore, such filters can present a stronger attenuation in the first spectral sub-window (blue) than in the second one (red), wherein the maximum transmittance ratio between each of said spectral sub-windows can be of 10, 100, or even 1000. As such, the transmittance in the red is advantageously strictly lower than 100%.

More generally, the maximum transmittance of the selective filtering element, in the spectral window, or in the considered spectral sub-windows, is preferably lower than 100%, so as to cause a brightness attenuation of the secondary light beam F2.

More particularly, said non-zero maximum transmittance can be lower than or equal to 65%, lower than or equal to 30%, lower than or equal to 10%, lower than or equal to 0.1%, or even lower than or equal to 0.01%.

In other words, the selective filtering element 6 can have an optical density, i.e. a value corresponding to the logarithm of its opacity, higher than or equal to 0.18, higher than or equal to 0.5, higher than or equal to 1, higher than or equal to 3, or even higher than or equal to 4.

Indeed, the inventor has noticed that a certain attenuation, or even a strong attenuation, for example in the red domain, is necessary to highlight the characteristic chromatic radiation permitting to locate the substance 2.

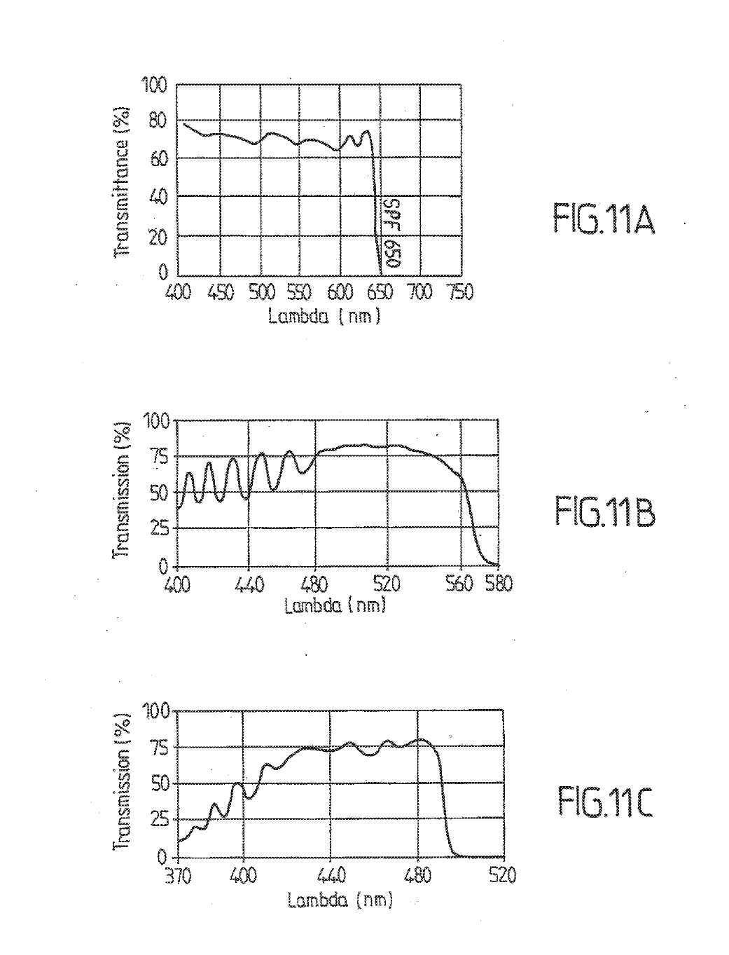

Of course, the spectral window according to the invention can be “one-block”, i.e. it extends over a single continuous portion of the visible spectrum, as it is the case for the filter I illustrated in FIG. 5 and FIG. 4A, or for the filter UV-2 illustrated in FIG. 10 and FIG. 4B, or it can be divided into a plurality of spectral sub-windows, as it is the case for the filter XIII illustrated in FIG. 8 or for the filter XI illustrated in FIG. 7.

Preferably, each spectral window or spectral sub-window has a homogeneous character as for the transmittance, i.e. the ratio of the maximum transmittance value in the considered spectral window by the minimum transmittance value in said spectral window is preferably lower than or equal to 1000, more preferentially lower than or equal to 100, and particularly preferentially lower than or equal to 10.

In other words, it is preferably considered by convention that the limits of a spectral window or of a spectral sub-window are defined by the bandwidth to −3 dB, −2 dB, or −1 dB with respect to the transmittance peak of said window.

Besides, although it is not excluded to use a narrow spectral window, having a bandwidth of the order of 5 nm or 10 nm, the whole spectral window, defined by the bandwidth or, if need be, by the sum of the bandwidths of the selective filtering element 6 in the domain of the visible spectrum, has preferably a spectral width Δλ that is higher than or equal to 20 nm, preferably higher than or equal to 30 nm, preferentially higher than or equal to 50 nm, and particularly preferentially higher than or equal to 100 nm.

Advantageously, a wide bandwidth may notably contribute to preserve, when picking up the image 10, the “polychrome” character of said image 10 over a range wide enough to be compatible with the spectral resolution of the human eye.

Preferably, a “continuously polychrome” spectral window (or sub-window) of observation can be used, i.e. a non-zero transmittance bandwidth extending over a continuous spectral range forming a sub-interval of the visible domain, which is capable of preserving chromatic information, and in particular a variety of hues, useful for discriminating the substance with respect to its environment.

This may be notably the case with a wide-band filtering element of the UV-2 filter type shown in FIG. 10 and in the Table of FIG. 4B.

Such a type of filter, that has a bandwidth located exclusively in the domain of the visible, cutting the UV and infrared, and more particularly comprised substantially between 420 nm and 680 nm, is capable of collecting simultaneously a plurality of chromatic radiations, and in particular, but not exclusively, radiations corresponding to the three primary colors.

By way of example, its transmittance can increase wholly with its wavelength, between its cutoff wavelengths, to form a spectral profile similar to a saw tooth.

According to an embodiment variant, the illumination means 4 may be invariant, i.e.

formed by a source whose spectrum of emission is substantially constant and not open to other adjustments than that of its whole intensity.

Indeed, the inventor has been able to verify that the phenomenon of chromatic luminescence of a same substance 2 is liable to take place for a great variety of conditions of illumination, and that it is thus possible, with constant conditions of illumination, i.e. using a same primary light beam F1, either to highlight substances 2 of very varied natures, or to detect a same substance 2 within various regions of the visible spectrum, by simply modifying the spectral properties of the selective filtering element 6.

Besides, according to a preferential characteristic that may constitute an invention as such, the illumination means 4 are designed for generating a primary light beam F1 that is free of infrared radiation.

More particularly, the spectrum of emission of the illumination means 4 is preferably located below 780 nm, preferentially below 750 nm, more preferentially below 700 nm, and still more preferentially below 650 nm.

If need be, this spectrum of emission may even be cut at lower values, far more distant from the red domain of the spectrum, and in particular lower than or equal to 570 nm, or even 430 nm.

Indeed, the inventor has noticed that, when the analyzed substrate is exposed, in addition to a visible radiation, to an infrared radiation whose wavelengths exceed the above-mentioned values, this infrared radiation can significantly disturb the phenomenon of visible chromatic radiation, up to scramble it, or even to make it disappear, under conditions of observation that are moreover constant.

Consequently, the elimination, at the source, of the infrared, near infrared, or even all or part of the red domain of the visible spectrum makes it possible to access to clearer chromatic information.

Preferably, the illumination means 4 can be designed for generating exclusively a visible light beam, substantially free of infrared and UV.

Indeed, the inventor has discovered that it is advantageous to use a primary beam F1 whose spectrum extends at least in part, preferably for the most part, and particularly preferentially in totality, in the visible domain, insofar as, according to a characteristic that may constitute an invention as such, it is possible, for many substances 2, to operate an excitation by means of a radiation located in the visible domain so as to obtain a radiation, in particular an effect of luminescence, and more particularly of fluorescence, also located in the visible domain, that makes it possible to differentiate these substances between each other, and more generally from the environment thereof.

Advantageously, this permits to avoid using a UV source in many applications.

According to an embodiment variant, the illumination means 4 comprise a white source with a wide spectrum of emission artificially providing a light of the “daylight” type, more or less close to the solar spectrum, but limited to the visible part of said spectrum, for example between 380 and 780 nm.

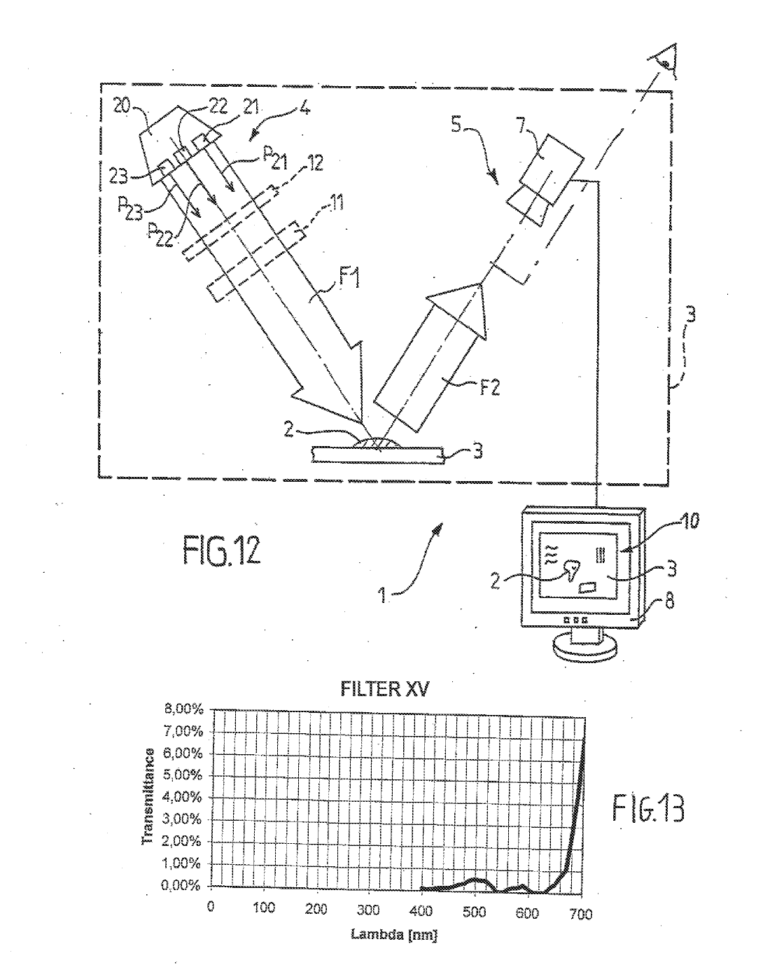

In particular, a white incandescent lamp can be used, for example an halogen lamp, to which a low-pass emission filter (or “Short Pass Filter”) 11, with for example a cut-off wavelength close to 650 nm, or even less, and for example of the order of 570 nm or 490 nm, as illustrated in FIGS. 11A, 11B and 11C.

According to this configuration, a heat-absorption filter 12 is also provided, which is intended to protect said low-pass filter from the heat released by the lamp.

According to a preferential variant of embodiment that may constitute an invention as such, the illumination means 4 comprise adjustment means that permit to modify the spectral characteristics of emission of the primary light beam F1, in particular and preferentially in the visible domain.

To that end, the illumination means 4 can comprise an invariant source with which is associated a tunable emission filter 11, or a plurality of emission filters liable to be arranged alternately and/or in superimposed arrangement between said source and the substrate 3, in the optical path of the primary light beam F1.

However, according to a preferential variant of embodiment constituting an independent invention, independently of the effect produced by the primary beam on the substance and of the nature of the detection means 5, the illumination means 4 comprise an intrinsically tunable light source 20, i.e. that does not need a filter for the modification of its spectrum of emission.

To that end, the illumination means 4 preferably comprise at least one first source 21 and one second source 22 that have distinct spectral characteristics, and that are capable of emitting simultaneously, in the domain of the visible spectrum, a first and a second sub-beam P₂₁, P₂₂, respectively, superimposed to each other, as well as means for adjusting the respective intensity of said first and second sub-beams.

Advantageously, the user can thus modify the spectrum of emission by additive synthesis, by constituting the primary light beam F1 through superimposition in the domain of the visible of at least two sub-beams P₂₁, P₂₂, of different colors, having preferably substantially the same spatial origin.

In other words, the illumination means 4 can advantageously comprise, or be exclusively formed of, a “metameric” tunable source 20.

Preferably, said metameric tunable source 20 comprise a third source 23, capable of emitting in the domain of the visible spectrum a third sub-beam P₂₃ of spectrum distinct from the first and second sub-beams, which can be superimposed to these latter, and of adjustable intensity.

In a particularly preferential manner, the first, second and third sources 21, 22, 23 are substantially monochromatic, and still more preferentially, they substantially correspond to the red, green and blue primary colors.

More particularly, said first, second and third sources 21, 22, 23 are preferably designed for emitting around 620 nm (red), 520 nm (green) and 460 nm (blue), respectively.

According to a preferential variant of embodiment, said first, second and third sources 21, 22, 23 are formed by LEDs, for example of a low electrical power of the order of 5 W.

Such an arrangement provides the device 1 according to the invention with several advantages, insofar as such a tunable source 20 makes it possible to:

work in direct exposition, without requiring the presence of any emission filter between the source and the substrate 3,

significantly reduce the electrical consumption of the device, which permits to consider implementing portable devices, supplied with batteries, with a good autonomy,

increase the compactness,

limit the heating of the device by using a “cold” light source,

increase the service life of said device with respect to incandescent lamps, and finally

provide the device with a great versatility by allowing it to “track down” the occurrence of a chromatic luminescence phenomenon in multiple illumination conditions.

According to a characteristic that may constitute an independent invention and that may apply to any type of optical analysis method, in particular a method according to the invention, the primary beam F1 may be generated by the superimposition, on the one hand, of a main wide-spectrum visible beam, with a preferably substantially constant intensity, and on the other hand, of one and/or the other of the sub-beams P₂₁, P₂₂, P₂₃, of variable intensity, whose visible spectrum is narrower than that of said main beam.

Preferentially, said main beam is generated artificially by a white source, in particular a so-called “hot” source of the “daylight” type, as described hereinabove, preferably free of infrared and/or substantially or even totally free of UV, whose spectrum is preferably substantially constant and whose intensity is preferably substantially invariant during the observation, and in particular during adjustment modification operated on the additional sub-beam(s) P₂₁, P₂₂, P₂₃.

Although it is conceivable that the spectral ranges, or wavelengths, of the sub-beams are located outside the wide spectral range occupied by the main beam, the spectrum of the latter preferably overlaps at least partially the spectra of the sub-beams, and is preferentially extended enough to fully cover and contain the spectral ranges of said sub-beams.

In a particularly preferential manner, this illumination combination comprising a wide and substantially invariant “background”, to which one or more narrow, or even substantially monochromatic, variable beams are added, is made by associating a white source with a metameric LED source, such as describe above.

Advantageously, such an arrangement makes it possible to explore the substrate 3 by modifying mainly, if not exclusively, the parameters of the sub-beams, and thus to module the main beam while benefiting from a ambient light that is permanent but not disturbing, provided by the main beam.

Besides, according to an embodiment variant, the illumination means 4 may comprise, in addition to a visible source or in substitution to the latter, a source of ultraviolet radiation.

Preferably, the device 1 has both a visible source and a UV source, liable to be used alternately.

The inventor has indeed noticed that certain substances 2, considered up to now as being inert, i.e. not liable to produce a directly visible fluorescence when they are exposed to a UV radiation, nevertheless produce, under this same UV radiation, a phenomenon of chromatic luminescence in the domain of the visible spectrum, which can be detected by means of the device 1 according to the invention.

In particular, it has been noticed that such a mode of detection permits to pick up fingerprints present on a paper substrate, and this, advantageously, without having to destroy or to spoil the substrate, unlike the methods known up to now, in which said substrate 3 was exposed to liquid, powdery or gaseous developer chemical agents.

Besides, the device 1 according to the invention preferably comprises an enclosure 30 designed for isolating it from the external light disturbances, and in particular for protecting the substrate 3 and the detection means 5 from the infrared radiations of the solar spectrum.

Of course, the invention is not limited to the few examples of application and adjustment provided herein. In particular, the one skilled in the art can determine, for each application, the conditions of selective filtering and/or of illumination appropriate to the substance searched for and to the substrate analyzed, in particular by means of test campaigns. For that purpose, it can combine freely to each other the different elements described in the present application.

Furthermore, it is conceivable to create reference works or charts for giving information to the one skilled in the art, and in particular the handwriting and forgery expert, about the adjustments to be performed to permit the detection of a particular substance in specified conditions.

An optical analysis method according to the invention will now be described in detail.

By simple way of convenience of description, it is preferably considered that said method is implemented on a device 1 as described above, with preferential reference to the examples given in the Table 1 hereinafter.

According to the invention, the optical analysis method is intended to discriminate a substance 2 present on a substrate 3 such as an object or a document.

As such, said method may in particular constitute a method for discriminating two inks (Examples 1 to 5), a method for reconstructing a forged or erased handwriting, a method for detecting non-pigment components of an ink, such as the fixative or drier agents, and in particular a method for observing the migration of said non-pigment components in the substrate 3 (Examples 6 and 7), a method for a non-destructive picking-up of fingerprints or palmprints (Examples 8 and 9), in particular on a paper substrate, a method for recovering chemical erasures (Example 10), a method for highlighting stains of corporal fluids, such as traces of saliva, sperm or sweat, a method for detecting natural or artificial pigments, for example present in the human, animal or vegetal biological tissues, or a method for detecting a micro-organism, such as fungus or mold having colonized the substrate, wherein said methods can lead in particular to the authentication of the substrate, and more particularly of the concerned document.

In a particularly preferential manner, the method according to the invention can be used to detect handwriting forgeries, and to assess the authenticity of official documents, identity documents, bank notes, fiduciary documents, etc.

If need be, it can also be adapted to identify traces or stains leaved by chemical or organic substances, and in particular by substances implemented in housework.

Of course, these examples are in no way limitative, and many other applications are conceivable, in particular in the field of judicial investigations.

The method according to the invention comprises a step (a) of illumination during which the substrate 3 is exposed to a primary light beam F1, such that said substrate 3 emits in response a secondary light beam F2, as well as a step (b) of detection during which said secondary beam F2 is collected and analyzed.

According to an important characteristic of the invention, the primary beam F1 is chosen so as to interact with the substance 2, in such a manner that the latter emits within the secondary light beam F2, in the domain of the visible spectrum, a characteristic chromatic radiation that is not directly discernable within said secondary beam F2, and in that the step (b) of detection comprises a sub-step (b1) of selective filtering during which the secondary light beam F2 is filtered, through a spectral window of the visible spectrum adapted to said characteristic chromatic radiation, so as to distinguish the substance 2 from its environment.

Thus, the method of optical analysis according to the invention advantageously permits to show a phenomenon of chromatic luminescence, which occurs naturally in the domain of the visible spectrum, but which has up to now remained hidden, because masked by the superimposition of the characteristic chromatic radiation of the background noise corresponding to the rest of the secondary light beam.

Preferably, according to said method, chromatic information is also or exclusively collected in the visible spectral domain distant from the red and/or infrared domain, and in particular below 650 nm, or even below 570 nm, or even below 430 nm, and the blindness or the saturation of the image with too intense red signals is avoided.

Advantageously, this method reveals said chromatic phenomenon by avoiding to exclude therefrom the discriminant information, i.e. the optical properties, in particular saturation and hue, which permit, after a selective filtering, to visually highlight the substance 2 with respect to its environment.

Preferably, the step (a) of illumination comprises a sub-step (a1) of emission adjustment during which the spectral characteristics of emission of the primary beam F1 are determined, among a plurality of possible settings.

Preferably, the primary light beam F1 is generated by a metameric source 20 capable of emitting simultaneously several sub-beams P₂₁, P_{22 and P}₂₃, each corresponding to one of the three primary colors, i.e. red, green and blue, such that, during the sub-step of emission adjustment (a1), the intensity of emission of each of said sub-beams is adjusted separately.

Thus, an almost infinity of different hues can be obtained, by superimposition of said beams, by additive synthesis, depending on the independent adjustment of the intensity of each primary color emitted.

In a particularly preferential manner, to that occasion, a cold light source, of the LED type, is implemented.

Moreover, the primary light beam emitted is preferably free of infrared radiation.

It is in particular the case in the example 4 of the Tableau 1 in which each primary color maximally radiates so as to visually reconstitute a white primary light beam, which is very advantageously free of any infrared radiation.

Besides, the sub-step of selective filtering (b1) preferably comprises a phase of attenuation during which the intensity of the secondary light beam F2 is reduced, in the spectral window, by means of a filter that has a non-zero maximum transmittance that is lower than or equal to 65%, lower than or equal to 30%, lower than or equal to 10%, lower than or equal to 0.1%, lower than or equal to 0.01%.

Furthermore, the method preferably comprises a step (c) of configuration, which can advantageously precede the step (b) of detection, during which the spectral window is configured by adjustment of the spectral characteristics of the selective filtering element 4.

As such, a set of several filters may in particular be arranged, wherein those filters can be interchanged, alternated or combined with each other by superimposition, so as to optimize the observation of the phenomenon of chromatic luminescence according to the substance and/or the conditions of illumination.

Preferably, the step (b) of detection comprises a sub-step (b2) of acquisition during which the image of the secondary light beam obtained during the sub-step (b1) of filtering is picked up and amplified, preferably by means of a wide-spectrum video camera, and a sub-step (b3) of reproduction during which said image is displayed in real colors.

Thus, advantageously, a simple process of picking up followed by an amplification is performed, without reprocessing nor chromatic transposition of the characteristic chromatic radiation of the substance, which advantageously makes it possible to substantially preserve the original chromatic character of the image 10, and to operate a discrimination of the substance as a function of its hue and/or saturation.

The Table 1 hereinafter provides some non-exhaustive examples of settings of the device 1 permitting the implementation thereof in various practical applications of the method described above.

According to a first application variant, corresponding to the Examples 1 to 5 of said Table 1, it is then possible to discriminate two inks 2, 2′, which have substantially the same color, herein black, and the same visual rendering at the daylight, but the chemical components, and in particular the pigments, of which react differently to a same primary light beam F1.

Thus, as illustrated in FIGS. 2A, 2B and 2C, it is possible to reveal an original trace 2 “Luc”, by putting in real transparency the forged trace 2′ “Claire” that covered it, and advantageously to reconstitute said trace so as to make it perfectly readable.

Such development may take place through brightening, highlighting and/or modification of the apparent hue of one of the inks with respect to the other. According to the filters used, the erasure of the forged trace or the darkening of the original trace can, while remaining perceptible, be revealed in various hues (red, blue, black . . . ) and be more or less pronounced.

As such, it can be noticed that the image 10 obtained is advantageously polychrome, wherein the apparent chromatic characteristics of the substance 2, and in particular its hue, can radically differentiate themselves from the hue(s) of the environment, unlike what would be observed if a simple monochromatic filter were used, for example.

In particular, as indicated in the Example 5, a green illumination may lead to the simultaneous observation, on a clear green background, of a pale pink forged trace and a blue-black original trace!

According to another application variant corresponding to the Examples 6 and 7 of the Table 1, and which may constitute an independent invention, it is possible to use the method to highlight a substance 2 or a mix of substances corresponding to one or several non-pigment components of an ink, such as the fixative or drier agents that, although being deposited on the substrate simultaneously with the pigments, remains fully invisible to the naked eye.

According to a first possibility, this application can be used to detect the order of superimposition of several traces that cross each other, so as to determine if the trace deemed to be the older (for example, the signature of a passport) is effectively covered with the trace deemed to be the more recent (for example, a passport stamp), and not the reverse.

According to a second possibility, this application is used to reconstruct a handwriting erased by mechanical or chemical erosion.

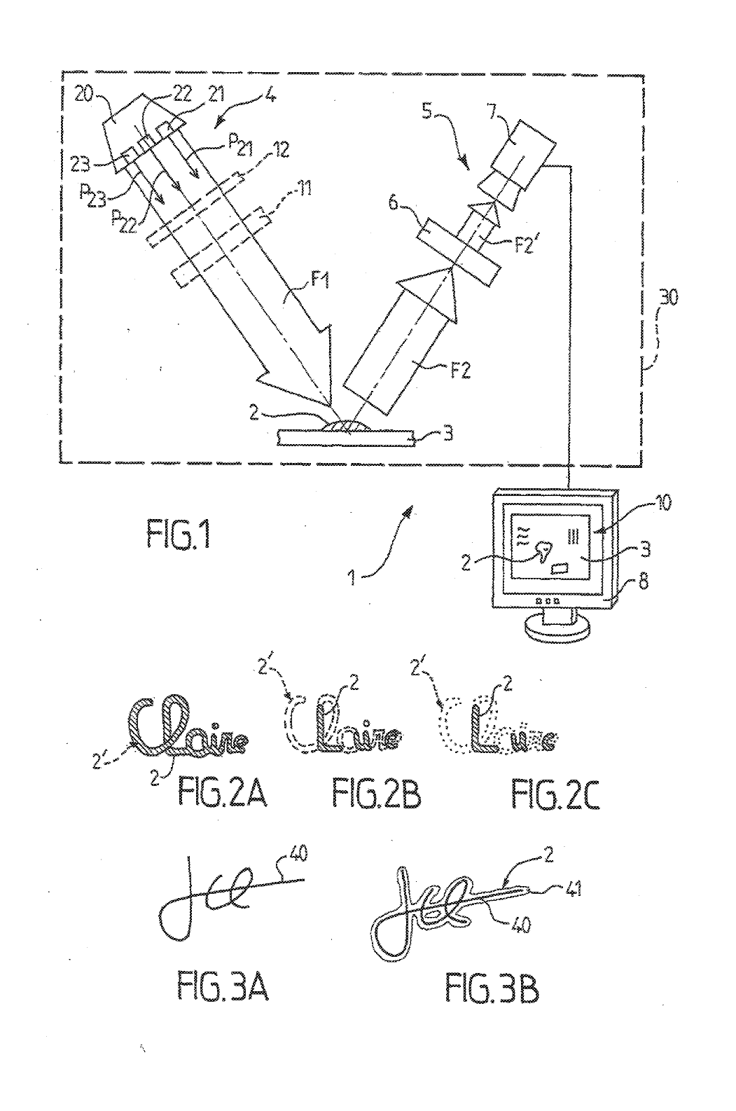

According to a third possibility, this application is used to detect and/or to measure the halation 41 that reveals the migration of the non-pigment components of an old ink around the pigmented and visible original line 40, as illustrated in FIGS. 3A and 3B or in the Examples 6 and 7, and thus, in particular, to perform the dating of a handwriting or the relative dating of two superimposed handwritings.

Indeed, the inventor has noticed that certain chemical components of ink, such as the fixative and drier agents used in the ballpoint pens, although being invisible to the naked eye, impregnate the paper forming the substrate by forming an invisible strain that extends progressively around the original trace, spreading farther and farther from the latter with time, and that it is possible to reveal this migration by the method according to the invention, without using a complex physicochemical analysis of the chromatography type.

Thus, according, on the one hand, to whether the halation 41 (or “aura”) exists (FIG. 3B) or not (FIG. 3A), and on the other hand, to whether it is, if need be, more or less extended, it is possible to assess the ancientness of the handwriting, and thus to compare it with the claimed date of making of the document.

It could be possible, for example, to detect an abuse of signature in blank at the origin of the forgery of a will.

This technique also applies to the study of line crossings, for example to detect a signature made on a pre-stamped passport (which is revealed by a reversed crossing of the lines, the signature and the halation being located above the stamp and spilling over the latter).

In a particularly advantageous manner, which may constitute an invention as such, the inventor has also discovered that the method according to the invention applies to the detection of fingerprints (Example 8), in particular on a paper substrate, by using jointly a UV source and a filtering element whose bandwidth is located in the visible domain, and more particularly a Filter UV-2 as described above and illustrated in FIG. 10.

According to an original inventive concept, the inventor has thus isolated a substance 2 by associating with an exclusive UV source a filtering element defining a spectral window of observation located exclusively in the domain of the visible spectrum, and advantageously polychromatic.

As such, it can be noticed that the method according to the invention makes it possible, if need be, by an appropriate selection of the selective filtering element 6, to collect wavelengths present in the secondary light beam but absent from the primary light beam.

In other words, the device 1 makes it possible, in certain conditions, to cause the production by the substance 2 of a characteristic chromatic radiation whose spectrum is different and/or offset with respect to the spectrum of the incident primary beam, and to pick up at least one part of the visible portion of this offset spectrum.

By way of example, by using a UV source emitting around 365 nm, the selective filtering element, for example a Filter UV-2, may be configured so as to acquire a useful signal corresponding to the chromatic radiation of a fingerprint in the low range of the visible spectrum, around 380 nm or 390 nm.

According to a preferential embodiment variant, it is also possible to reveal fingerprints using a primary beam located exclusively in the visible domain, and in particular by means of a metameric source as described above (Example 9).

To that end, a red metameric source set as follows: R=100%, G=0%, B=0%, and associated with a selective filtering element XV, may notably be used, to make appear in fluorescent pink over a burgundy background a fingerprint initially invisible on a white paper; in doing so, it can also be noticed that a handwriting made with a blue ballpoint pen on the same paper then appears in an almost white, lightly pinkish, fluorescent hue.

In a particularly advantageous manner, the optical method according to the invention thus permits to non-destructively reveal fingerprints.

Finally, the inventor has also discovered possible applications of his/her method for recovering traces erased by a chemical washing, for example to detect checks forged by erasure and rewriting with the sum or the payee (Example 10).

According to an original inventive concept, thanks to the method according to the invention, an illumination means 4 other than a UV source may be used for that application, notably made of a white source simply filtered to attenuate or eliminate the red and infrared radiations, as described above.

This detection of chemical erasures under visible light, and in particular under a white light, is advantageously made possible by choosing an appropriate selective filtering element whose bandwidth is comprised in the domain of the visible spectrum.

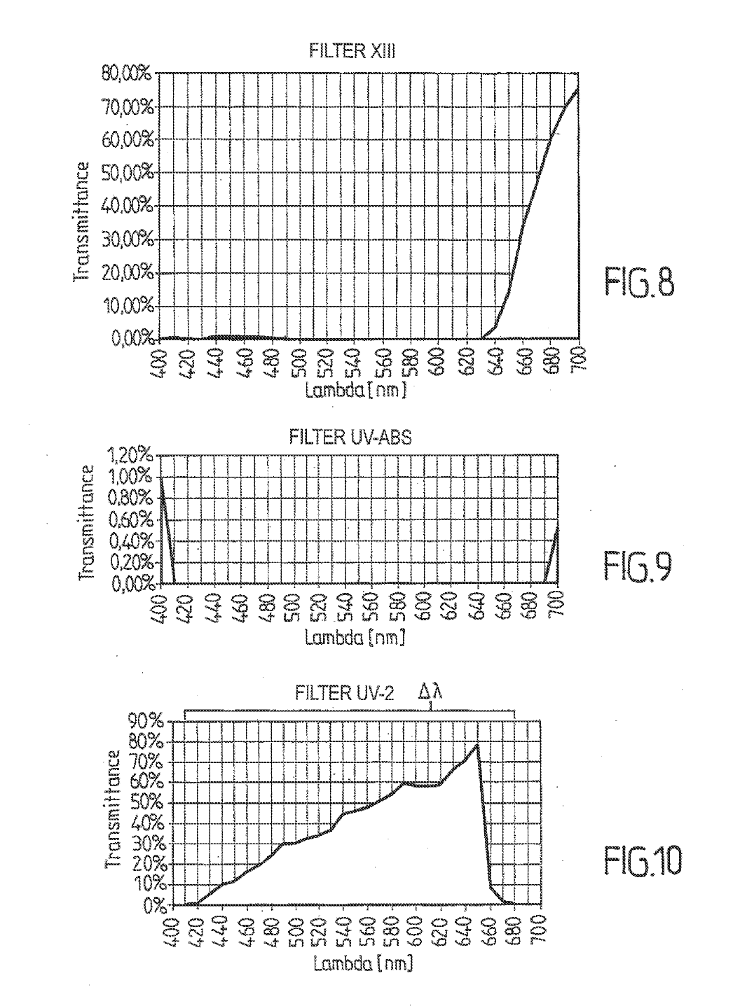

For example, it may be used for that purpose a filter having a first narrow sub-window in the violet, and a second narrow sub-window in the red, as it is the case of the Filter UV-ABS illustrated in FIG. 9.

TABLE 1
Examples of Applications

| Application | N^{o} | Source | Filtering | Observed result |
|---|---|---|---|---|
| Discrimination of two | 1 | Filtered | Filter I | On a violet background, “Claire” |
| inks: two traces of | | white | | becomes transparent, of pale |
| black-ink ballpoint | | halogen | | violet hue, and shows through |
| pens are superimposed | | <650 nm | | “Luc” in dark violet. |
| to each other so as to | 2 | Filtered | Filter XI | On a grey background, “Claire” |
| forge a check of grey- | | white | | becomes transparent, of very |
| beige background: | | halogen | | pale blue hue, and shows through |
| “Claire” hides “Luc”. | | <650 nm | | very clearly “Luc” in black. |
| | 3 | Filtered | Filter III | On a grey-blue background, |
| | | white | | “Claire” becomes transparent, of |
| | | halogen | | pale red hue, and shows through |
| | | <650 nm | | “Luc” in dark red. |
| | 4 | White | Filter XIII | On a grey-blue background, |
| | | metameric | | “Claire” becomes transparent, of |
| | | R = G = B = | | pale pink hue, and shows through |
| | | 100% | | “Luc” in dark blue. |
| | 5 | Green | Filter XIV | On a green background, “Claire” |
| | | metameric | | becomes transparent, of pink |
| | | G = 100% | | hue, and shows through “Luc” in |
| | | R = B = 0% | | black. |
| Detection of the | 6 | Filtered | Filter I | On a violet background, |
| migration of non- | | white | | highlighting of a very bright pale |
| pigment compounds of | | halogen | | violet halation around the dark |
| an ink: on a white-grey | | <650 nm | | blue handwriting trace. |
| paper substrate, dating | 7 | Filtered | Filter III | On a grey background, |
| of the trace with respect | | white | | highlighting of a very bright pink |
| to the substrate or to an | | halogen | | halation around the blue-black |
| official stamp - | | <650 nm | | handwriting trace. |
| authentication of a will | | | | |
| or a passport | | | | |
| Visualization of a | 8 | UV | Filter | On a grey background, the trace |
| fingerprint on a paper | | | UV-2 | of the fingerprint appears in |
| substrate | | | | blue-violet |
| | 9 | Red | Filter XV | On a dark burgundy background, |
| | | metameric | | the fingerprint appears in |
| | | R = 100% | | fluorescent pink |
| | | G = B = 0% | | |
| Recovering of chemical | 10 | Filtered | Filter | On a blue background, |
| erasures (forged | | white | UV-ABS | disappearance of the added |
| checks) | | halogen | | inscriptions and visualization in |
| | | <650 nm | | black of the erased prior traces. |

Besides, the invention may relates as such to an method of optical analysis for discriminating a substance 2 present on a substrate 3 such as an object or a document, said method comprising a step (a) of illumination during which the substrate is exposed to a primary light beam F1, such that said substrate emits in response a secondary light beam F2, as well as a step (b) of detection during which said secondary beam is collected and analyzed, the step (a) of illumination comprising a sub-step (a1) of emission adjustment during which the spectral characteristics of emission of the primary beam F1 are determined, among a plurality of possible settings, by means of a metameric source comprising at least one first and one second sources 21, 22, that have distinct spectral characteristics and that are capable of emitting simultaneously, in the visible domain, a first and a second sub-beams P₂₁, P₂₂, by adjusting the intensity of said first and second sub-beams respectively.

Thus, preferably, the metameric source comprises a third source 23 capable of emitting a third sub-beam P₂₃ that can be superimposed to the first and second beams and of adjustable intensity, the first, second and third sources being substantially monochromatic and corresponding substantially to the primary colors.

Besides, whatever the method implemented, the latter preferably comprises a step of exploration during which the spectral characteristics of the primary beam are modified to track down the occurrence of a phenomenon of chromatic luminescence of the substance 2.

Indeed, the use of a tunable source, in particular a metameric source, makes it possible to modify the conditions of illumination of the substance by the primary beam F1, and in particular the spectral mixture of the components of the latter, such that the user can, while continuing to visualize the secondary beam F2, and more particularly the image 10, vary the parameters of illumination until obtaining a response by luminescence of the substance 2, in particular by fluorescence, that he/she assesses as being satisfactory.

Advantageously, the step of exploration may continue iteratively, according to a free or predetermined protocol of exploration, by varying one after the other, according to various combinations, the levels of intensity of each of the three sources generating the sub-beams, until the combination obtained makes appear the substance 2, i.e. generates a characteristic radiation perceptible in the environment thereof.

Furthermore, the primary beam F1 is preferably free of ultraviolet, and preferably also of infrared, and causes a luminescence of the substance 2 in the domain of the visible, which luminescence may have a hue very distinct from the apparent hue resulting from the additive synthesis of the sources forming the primary beam.

Although the method described above can be implemented in the above-mentioned applications to obtain a “hidden”, non-directly discernable, chromatic characteristic radiation, which requires a selective filtering element 6 as described hereinabove to be perceived by the observer, said method may also be used, at least in the case of certain substances and according to a characteristic that constitutes an independent invention, to produce an “apparent” chromatic radiation, wherein the adjustment of the primary beam permits the latter to cause a luminescence of the substance 2 that is directly discernable by the naked eye in the secondary beam, without needing any selective filtering element 6, as illustrated in FIG. 12.

Advantageously, the image 10 can then result either from the direct picking up of the “raw” secondary beam by the acquisition element 7 and from the substantially identical retranscription of the information contained in this beam on the display element 8, or from the visualization by the naked eye of said “raw” secondary beam, the image 10 coinciding with the rendering of the physical area of the observed substrate 3 containing the substance 2, as it appears directly to the observer under the illumination by the primary beam.

Indeed, the inventor has discovered that it is possible to excite certain substances, and in particular inks, simply by means of a primary beam that is visible and advantageously free of UV, the red, green and blue components of which was suitably parameterized, so as not only to obtain a luminescence of these substances, but above all to reinforce said luminescence by giving it such an intensity that it becomes possible to distinguish by the naked eye, by a direct observation of the thus-illuminated substrate 3, the characteristic radiation of the substance, and thus to directly visualize, in particular by a hue, intensity or saturation contrast, the substance 2 from the rest of the substrate.

By way of example, an intensity setting R=0%, G=100%, B=100%, has thus made possible to highlight directly three samples of pink inks of various tones, deposited on a white paper by felts of the brand Reynolds-094®, respectively in dark green, pale pink and dark blue on a pale clear blue background.

Advantageously, the device 1 can be adapted to the implementation of the set of above-mentioned method variants, and can notably comprise a removable or retractable selective filtering element 6, that can be alternately inserted in the secondary beam, between the substrate and the observer or the acquisition element 7, or on the contrary removed from the latter. To that end, said device 1 can notably comprise a mobile support, such as a barrel comprising several slots, one of which remains empty, or occupied by an optically neutral element, so as to permit a direct perception of said secondary beam, as returned by the observed area of the substrate, by the eye or by the acquisition element 7, whereas the other slots will be occupied by several selective filtering elements 6.

Of course, the one skilled in the art can adapt freely the above-described methods and devices, in particular by extracting or combining the peculiar characteristics thereof, according to the substances and applications considered.

Thus, the device 1 and the methods according to the invention are particularly simple and versatile, as well regarding the diversity of nature of the substances they permit to analyze as regarding the variety of possible fields of application they offer, in particular within the framework of judicial enquiry.

Furthermore, the methods and the device according to the invention have advantageously a particularly high discrimination power, insofar as they preserve information of chromatic nature permitting a fine distinction of the substance with respect to its environment.

Moreover, such distinction may advantageously be operated by the simple visualization of the image 10, either directly obtained by the selective filter, or, in some cases, by direct observation by the naked eye, which guarantees the intuitive and ergonomic character of the implementation of said methods.

Moreover, the invention makes it possible to perform a successful detection by means of low-power light sources and relatively cheap components.

Finally, in a particularly advantageous manner, this method protects not only the skin and the eyes of the user, but also the integrity of the sample, and in particular it does not alter the structure of the substrate or of the substance examined. In judicial matter, an examination method is thus provided, which has the very significant advantage not to destroy nor spoil the evidence.

### INDUSTRIAL APPLICABILITY

The invention finds an industrial application in the optical analysis of substances, in particular pigments or colorants, and in particular in the forensic examination of objects or documents, notably for judicial enquiries, as well as for the design and the

1. A method of optical analysis for discriminating a substance (2) present on a substrate (3) such as an object or a document, said method comprising a step (a) of illumination during which the substrate is exposed to a primary light beam (F1), such that said substrate emits in response a secondary light beam (F2), as well as a step (b) of detection during which said secondary beam is collected and analyzed, said method being characterized in that the primary light beam is chosen so as to interact with the substance (2) in such a manner that the latter emits within the secondary light beam, in the domain of the visible spectrum, a characteristic chromatic radiation that is not directly discernable within said secondary light beam, and in that the step (b) of detection comprises a sub-step (b1) of selective filtering during which the secondary light beam is filtered, through a spectral window of the visible spectrum adapted to said characteristic chromatic radiation, so as to extract from said secondary beam an image (10) of a surface element of the substrate (3) that is extensive enough to contain at least one area containing the substance (2) and at least one reference area free from said substance, forming the environment of said substance, said image (10) containing simultaneously, on the one hand, a first visible signal corresponding to the characteristic radiation of the substance and, on the other hand, a second visible signal corresponding to the response of the environment, said first and second signals being visually distinct from each other to permit a user to distinguish the substance (2) from the environment thereof.

2. A method according to claim 1, characterized in that the first and second signals make appear, on the image (10), hue differences perceptible by the eye between the substance (2) and the environment thereof.

3. A method according to claim 1, characterized in that the step (a) of illumination comprises a sub-step (a1) of emission adjustment during which the spectral characteristics of emission of the primary beam (F1) are determined, among a plurality of possible settings.

4. A method according to claim 3, characterized in that the primary light beam is generated by a metameric source (20) capable of emitting simultaneously several sub-beams each corresponding to one of the three primary colors, and in that, during the sub-step (a1) of emission adjustment, the intensity of emission of each of said sub-beams is adjusted separately.

5. A method according to claim 1, characterized in that it implements a cold light source, of the LED type.

6. A method according to claim 1, characterized in that the primary light beam is free from infrared radiation.

7. A method according to claim 1, characterized in that the primary beam forms a visible light beam substantially free from ultraviolet.

8. A method according to claim 1, characterized in that the excitation of the substance (2) by the primary beam (F1) produces the luminescence of said substance (2).

9. A method according to claim 1, characterized in that the sub-step (b1) of selective filtering comprises a phase of attenuation during which the intensity of the secondary light beam (F2) is reduced, in the spectral window, by means of a filter having a non-zero maximum transmittance, lower than or equal to 65%, lower than or equal to 30%, lower than or equal to 10%, lower than or equal to 0.1%, or even lower than or equal to 0.01%.

10. A method according to claim 1, characterized in that, during the sub-step of selective filtering (b1), chromatic information located below 650 nm, below 530 nm, or even below 470 nm, is collected through the spectral window.

11. A method according to claim 1, characterized in that the spectral width (αλ) of the spectral window is greater than or equal to 20 nm, greater than or equal to 30 nm, greater than or equal to 50 nm, or even greater than or equal to 100 nm.

12. A method according to claim 1, characterized in that it comprises a step (c) of configuration during which the spectral window is configured by adjustment of the spectral characteristics of a selective filtering element (4).

13. A method according to claim 1, characterized in that the step of detection (b) comprises a sub-step (b2) of acquisition during which the image of the secondary light beam obtained during the sub-step of filtering is picked up and amplified, preferably by means of a wide-spectrum video camera, and a sub-step (b3) of reproduction during which said image is displayed in real colors.

14. A method of optical analysis for discriminating a substance (2) present on a substrate (3) such as an object or a document, said method comprising a step (a) of illumination during which the substrate is exposed to a primary light beam (F1), such that said substrate emits in response a secondary light beam (F2), as well as a step (b) of detection during which said secondary beam is collected and analyzed, said method being characterized in that the step (a) of illumination comprises a sub-step (a1) of emission adjustment during which the spectral characteristics of emission of the primary beam (F1) are determined, among a plurality of possible settings, by means of a metameric source comprising at least one first and one second sources (21, 22) that have distinct spectral characteristics and that are capable of emitting simultaneously, in the visible domain, a first and a second sub-beams (P21, P22), by adjusting the intensity of said first and second sub-beams respectively.

15. A method according to claim 14, characterized in that it comprises a sub-step of exploration during which the spectral characteristics of the primary beam are modified to track down the occurrence of a phenomenon of chromatic luminescence of the substance (2).

16. A method according to claim 14, characterized in that the metameric source comprises a third source capable of emitting a third sub-beam that can be superimposed to the first and second beams and of adjustable intensity, and in that the first, second and third sources are substantially monochromatic and correspond substantially to the primary colors.

17. A method according to claim 14, characterized in that the primary beam is substantially free of ultraviolet and causes a luminescence of the substance (2) in the domain of the visible.

18. A method according to claim 14, characterized in that the primary beam (F1) is generated by superimposition, on the one hand, of a wide-spectrum visible main beam, of substantially constant intensity, and on the other hand, of one and/or the other of the sub-beams of variable intensity whose visible spectrum is narrower than that of said main beam and overlaps at least in part the latter, or even is contained in it.

19. A method according to claim 14, characterized in that the luminescence of the substance (2) is directly discernable by the naked eye in the secondary beam.

20. A method according to claim 14, characterized in that it forms a method for authenticating documents, a method for reconstructing a forged or erased handwriting trace, a method for detecting non-pigment components of an ink, a method for a non-destructive picking-up of fingerprints or palmprints, a method for highlighting stains of corporal fluids, a method for detecting pigments present in biological tissues, a method for detecting micro-organisms of the fungus type, in particular on a paper substrate.

21. An optical analysis device (1) for implementing a method according to claim 14 so as to discriminate a substance (2) from the environment thereof.
